(19) United States
(12) Patent Application Publication
(10) Pub. No.: US 2026/0358557 A1
(43) Pub. Date: Nov. 12, 2026

(54) COATED PHOTONIC INTEGRATED CIRCUIT (PIC) WITH OUTPUT APERTURE(S)

(71) Applicant: Quantinuum LLC, Broomfield, CO (US)

(72) Inventors: Christopher T. ERTSGAARD, Champlin, MN (US); Ra'Anan I. TOBEY, Broomfield, CO (US)

(21) Appl. No.: 18/610,803

(22) Filed: Mar. 20, 2024

Related U.S. Application Data
(60) Provisional application No. 63/491,164, filed on Mar. 20, 2023.

(51) Int. Cl. G02B 6/122; G02B 6/136

(52) U.S. Cl. CPC G02B 6/122; G02B 6/136

(57) ABSTRACT

A coated photonic integrated circuit (PIC) with output apertures is provided. The PIC includes a PIC body; at least one input defined in the PIC body; one or more outputs defined in an exit side of the PIC body; and at least one waveguide defined in the PIC body, the at least one waveguide optically coupling the at least one input to a respective output of the one or more outputs. A coating covers an exterior surface of at least the exit side of the PIC body and one or more apertures are formed through the coating. Each aperture of the one or more apertures coincides with a respective output of the one or more outputs. The coating is optically opaque or metal.

### CROSS-REFERENCE TO RELATED APPLICATIONS

This application claims priority to U.S. Application No. 63/491,164, filed Mar. 20, 2023, the content of which is incorporated herein by reference in its entirety.

### TECHNICAL FIELD

Various embodiments relate to a photonic integrated circuit (PIC) having respective etched and/or milled apertures corresponding to one or more outputs of the PIC. Various embodiments relate to a PIC having respective etched and/or milled apertures corresponding to one or more outputs of the PIC configured for quantum computing applications.

### BACKGROUND

In various systems, it is important to be able to deliver laser and/or optical beams to dense one-or-more dimensional arrays of locations at precision spacings and mode profiles. In conventional PICs, some of the light provided to a PIC input may not be coupled into the guided mode or may be scattered out of the guided mode as the light travels through the PIC. Through applied effort, ingenuity, and innovation many deficiencies of such prior PICs have been solved by developing solutions that are structured in accordance with the embodiments of the present invention, many examples of which are described in detail herein.

### BRIEF SUMMARY OF EXAMPLE EMBODIMENTS

Example embodiments provide a coated PIC that comprises one or more apertures formed through the coating that each correspond to a respective output of the PIC. Example embodiments, provide methods for fabricating such PICs, systems including such PICs, and/or the like. In an example embodiment, a coated PIC comprising one or more output apertures that each correspond to a respective output of the PIC is part of a beam delivery system of a quantum system such as a quantum computer (e.g., a quantum charge-coupled device (QCCD)-based quantum computer). In various embodiments, the PIC is coated in a metallic, optically opaque (with respect to the wavelengths for which the waveguides of the PIC are configured to guide), and/or conductive coating.

According to one aspect, a photonic integrated circuit (PIC) is provided. In an example embodiment, the PIC comprises a PIC body; at least one input defined in one or more entrance sides of the PIC body; one or more outputs defined in one or more exit sides of the PIC body; and at least one waveguide defined in the PIC body, the at least one waveguide optically coupling the at least one input to a respective output of the one or more outputs. The PIC further includes a coating that covers an exterior surface of at least the one or more exit sides of the PIC body. One or more apertures are formed through the coating. Each aperture of the one or more apertures coincides with a respective output of the one or more outputs. The coating is optically opaque or metal.

In an example embodiment, the coating further covers the exterior surface of at least one lateral side of the PIC body.

In an example embodiment, the coating further covers the exterior surface of at least one of the one or more entrance sides.

In an example embodiment, the coating extends out from the exterior surface of the PIC body by a thickness in a range of 15 nm to 1 μm.

In an example embodiment, at least one of the one or more apertures is etched or milled into the PIC body to form a respective first sidewall, a respective second sidewall, and a respective back wall and the respective output is disposed on the respective back wall of the at least one aperture.

In an example embodiment, each of the one or more apertures is etched or milled into the PIC body to form respective sidewalls and a respective back wall and the respective output is disposed on the respective back wall of the respective aperture.

In an example embodiment, a sidewall angle between a respective sidewall and the respective back wall of the respective etched and/or milled aperture and a normal to the respective back wall is in a range of -10 to 10 degrees.

In an example embodiment, a length of the respective sidewalls in a direction substantially parallel to an emission direction of the one or more outputs is configured to prevent generation of a diffraction pattern in light outputted through the one or more outputs.

In an example embodiment, a distance between opposite respective sidewalls of the respective aperture is larger than an expected mode field diameter of an optical beam the respective output is configured to emit and/or output.

In an example embodiment, the PIC further includes one or more alignment features formed on or in the PIC body and that is detectable through the coating.

In an example embodiment, the PIC body comprises one or more claddings enclosing the at least one waveguide in directions perpendicular to an emission direction of the at least one waveguide.

In an example embodiment, at least one of the one or more outputs comprises a signal manipulation element.

In an example embodiment, the one or more outputs include a first output and a second output and the at least one waveguide include a first waveguide and a second waveguide, the first waveguide optically coupled to the first output and the second waveguide optically coupled to the second output, and the PIC further includes a trench baffle disposed at least one of

(a) between the first output and the second output or (b) between at least a portion of the first waveguide and at least a portion of the second waveguide.

According to another aspect, a method of fabricating a PIC is provided. In an example embodiment, the method includes forming a PIC body including at least one input, one or more outputs, and at least one waveguide optically coupling the at least one input to at least a respective output of the one or more outputs; (conformally) depositing a coating onto an exterior surface of one or more exit sides of the PIC body; and forming one or more apertures through the coating. Each aperture of the one or more apertures coincides with a respective output of the one or more outputs. The coating is optically opaque or metal.

In an example embodiment, the one or more apertures are formed through etching or milling.

In an example embodiment, the one or more apertures are formed using lithographical etching, a lift-off process, or shadow masking.

In an example embodiment, the one or more apertures are formed using a focused ion beam (FIB).

In an example embodiment, the coating further covers the exterior surface of at least one lateral side of the PIC body.

In an example embodiment, at least one of the one or more apertures is etched into the PIC body to form a respective first sidewall, a respective second sidewall, and a respective back wall and the respective output is disposed on the respective back wall of the at least one aperture.

In an example embodiment, the coating extends out from the exterior surface of the PIC body by a thickness in a range of 15 nm to 1 μm.

In an example embodiment, the coating is deposited on the exterior surface using at least one of (a) sputter deposition, (b) atomic layer deposition (ALD), or (c) evaporation deposition.

In an example embodiment, the method further includes, prior to depositing the coating, forming one or more alignment features on or in the PIC body, wherein the one or more alignment features are detectable after the coating is deposited on the exterior surface.

In an example embodiment, at least one of the one or more alignment features are used in alignment of the PIC body for the etching of the PIC body to form the one or more etched and/or milled apertures.

In an example embodiment, the method further includes, prior to depositing the coating on the exterior surface, applying an adhesion layer to the exterior surface.

In an example embodiment, the method further includes, prior to depositing the coating on the exterior surface, etching a trench configured to provide a trench baffle (e.g., when the coating has been deposited thereon).

In an example embodiment, at least one of the one or more outputs comprises a signal manipulation element.

In an example embodiment, the one or more outputs include a first output and a second output and the at least one waveguide include a first waveguide and a second waveguide, the first waveguide optically coupled to the first output and the second waveguide optically coupled to the second output, and the PIC further includes a trench baffle disposed at least one of (a) between the first output and the second output or (b) between at least a portion of the first waveguide and at least a portion of the second waveguide.

According to another aspect, a quantum system is provided. In an example embodiment, the quantum system comprises a confinement apparatus, one or more manipulation sources, and at least one beam delivery system configured to provide manipulation signals generated by the one or more manipulation sources to respective locations defined at least in part by the confinement apparatus. The beam delivery system comprises a PIC including a PIC body; at least one input defined in one or more input surfaces of the PIC body; one or more outputs defined in the PIC body; and at least one waveguide defined in the PIC body, the at least one waveguide optically coupling the at least one input to a respective output of the one or more outputs. The PIC further includes a coating that covers an exterior surface of at least the one or more exit sides of the PIC body. One or more apertures are formed through the coating. Each aperture of the one or more apertures coincides with a respective output of the one or more outputs. The coating is optically opaque or metal.

In an example embodiment, the coating further covers the exterior surface of at least one lateral side of the PIC body.

In an example embodiment, the coating further covers the exterior surface of at least one of the one or more entrance sides of the PIC body.

In an example embodiment, the coating extends out from the exterior surface of the PIC body by a thickness in a range of 15 nm to 1 μm.

In an example embodiment, at least one of the one or more apertures is etched or milled into the PIC body to form a respective first sidewall, a respective second sidewall, and a respective back wall and the respective output is disposed on the respective back wall of the at least one aperture.

In an example embodiment, each of the one or more apertures is etched or milled into the PIC body to form respective sidewalls and a respective back wall and the respective output is disposed on the respective back wall of the respective aperture.

In an example embodiment, a sidewall angle between a respective sidewall and the respective back wall of the respective etched and/or milled aperture and a normal to the respective back wall is in a range of -10 to 10 degrees.

In an example embodiment, a length of the respective sidewalls in a direction substantially parallel to an emission direction of the one or more outputs is configured to prevent generation of a diffraction pattern in light outputted through the one or more outputs.

In an example embodiment, a distance between opposite respective sidewalls of the respective etched and/or milled aperture is larger than an expected mode field diameter of an optical beam the respective output is configured to emit and/or output.

In an example embodiment, the PIC further includes one or more alignment features formed on or in the PIC body and that is detectable through the coating.

In an example embodiment, the PIC body comprises one or more claddings enclosing the at least one waveguide in directions perpendicular to an emission direction of the at least one waveguide.

In an example embodiment, at least one of the one or more outputs comprises a signal manipulation element.

In an example embodiment, the one or more outputs include a first output and a second output and the at least one waveguide include a first waveguide and a second waveguide, the first waveguide optically coupled to the first output and the second waveguide optically coupled to the second output, and the PIC further includes a trench baffle disposed at least one of (a) between the first output and the second output or (b) between at least a portion of the first waveguide and at least a portion of the second waveguide.

In an example embodiment, the PIC is formed on a substrate housing the confinement apparatus.

In an example embodiment, the PIC is formed on a substrate configured to be secured with respect to a substrate housing the confinement apparatus or to be packaged with the substrate housing the confinement apparatus.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A provides a schematic diagram of an example QCCD-based quantum computer system that includes a PIC, in accordance with an example embodiment.

FIG. 1B provides a schematic diagram of another example QCCD-based quantum computer system that includes a PIC, in accordance with an example embodiment.

FIG. 2 provides a top diagram of an example PIC, in accordance with an example embodiment.

FIG. 3 provides a cross-sectional view of the PIC illustrated in FIG. 2 taken along line AA, in accordance with an example embodiment.

FIG. 3A provides a cross-sectional view of an example PIC, in accordance with an example embodiment.

FIG. 4 provides an exit side view of the PIC illustrated in FIG. 2, in accordance with an example embodiment.

FIG. 5 provides a perspective view of the PIC illustrated in FIG. 2, in accordance with an example embodiment.

FIG. 6 provides a close-up perspective view of a portion of a PIC between two adjacent etched and/or milled apertures of a PIC, in accordance with an example embodiment. FIG. 7A provides a cross-sectional view of a portion of another example PIC, in accordance with an example embodiment.

FIG. 7B provides a top view of the example PIC illustrated in FIG. 7A. FIG. 8A provides an exit view of another example PIC, in accordance with an example embodiment.

FIG. 8B provides a top view of the example PIC illustrated in FIG. 8A.

FIG. 9 provides a flowchart illustrating processes, procedures, operations, and/or the like for fabricating a PIC, in accordance with an example embodiment.

FIG. 10 provides a schematic diagram of an example controller that may be used in accordance with an example embodiment.

FIG. 11 provides a schematic diagram of an example computing entity that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

As described above, in various systems, such as atomic systems or quantum systems, for example, it is important to be able to precisely and accurately, in terms of position, spacings, mode profile, polarization, frequency, and/or phase, deliver one or more laser beams to locations of a one or more dimensional array of locations. For example, in atomic systems such as atomic clocks, Bose-Einstein condensate systems, trapped ion systems, QCCD-based quantum computer, and/or other atomic and/or quantum systems, precise and accurate laser beam delivery is important for various uses of the system, manipulating the system, and/or the like.

In conventional PICs, some of the light provided to a PIC input may not be coupled into the guided mode or may be scattered out of the guided mode as the light travels through the PIC. For example, some of the light being provided to an input of the PIC may not be coupled into a waveguide via the input. In another example, some of the light propagating through a waveguide of the PIC may be scattered by the roughness of the edges of the waveguide. Some of the uncoupled and/or scattered light may propagate out through the exit side of the PIC. This unguided light may cause the optical cross talk between various outputs of the PIC. For example, the uncoupled and/or scattered light may interfere with the array of laser and/or optical beams provided via the outputs of the PIC, resulting in increased scattering of light out of laser and/or optical beams of the array. For example, in some applications it is desired to have 60-70 dB of extinction between adjacent laser and/or optical beams output by the PIC. However, conventional PICs achieve an extinction between adjacent laser and/or optical beams output by the PIC of about 50 dB. Therefore, technical problems regarding controlling, preventing, and/or removing the uncoupled and/or scattered light from the output of the PIC.

Various embodiments provide technical solutions to these technical problems. For example, in various embodiments, one or more outputs of the PIC are disposed within and/or correspond to a respective etched and/or milled aperture formed into the PIC body. In various embodiments, a coating, such as a metallic or optically opaque (with respect to the wavelengths for which the waveguides of the PIC are configured to guide) coating is deposited, applied, and/or disposed on the exterior surface of the PIC body. The etched and/or milled apertures extend through the coating into the PIC body to provide an optical aperture through the coating. The coating prevents light from exiting the exit side of the PIC between the etched and/or milled apertures. The geometry of the etched and/or milled apertures prevents light that is traveling in a direction transverse and/or not substantially parallel to the emission direction of the respective outputs of the PIC to be blocked or attenuated. Thus, light traveling in a direction transverse and/or not substantially parallel to the emission direction of the respective outputs of the PIC is prevented from reaching the image plane(s) of the respective outputs. As a result, the extinction between adjacent laser and/or optical beams output by the PIC is able to reach 60 dB or more and optical crosstalk of the PIC is significantly reduced.

### Exemplary Quantum Computer System

PICs of various embodiments may be used in a wide array of applications, including atomic systems and quantum systems. For example, some embodiments provide a QCCD-based quantum computer that includes one or more PICs with coatings and etched and/or milled apertures formed through at least the respective coating.

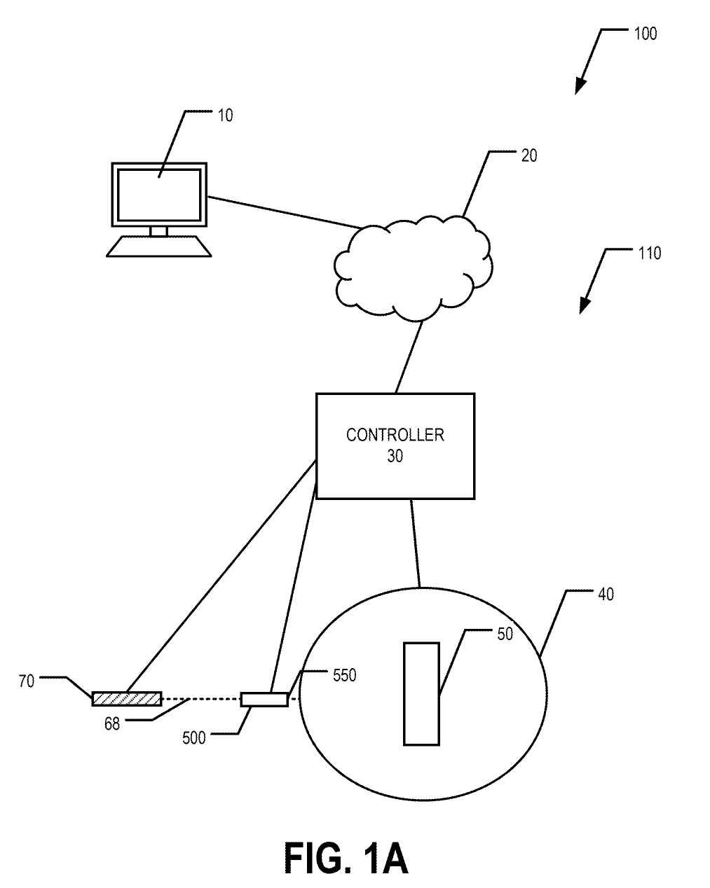

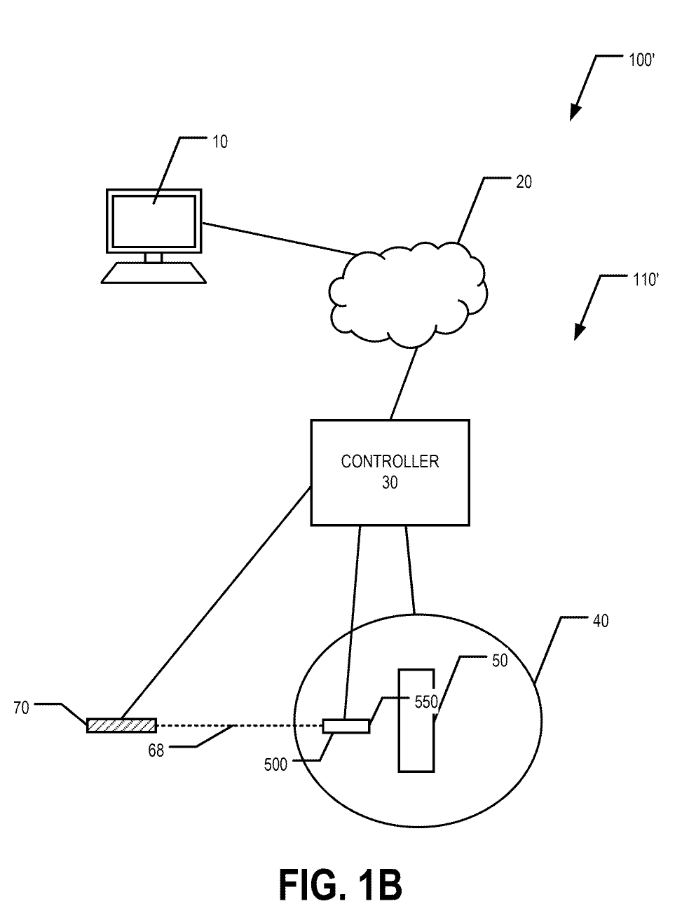

FIG. 1A provides a schematic diagram of an example QCCD-based quantum computer system 100, in accordance with an example embodiment. The QCCD-based quantum computer system includes a PIC 500 that is disposed external to or outwith a cryogenic and/or vacuum chamber 40. FIG. 1B provides a schematic diagram of an example QCCD-based quantum computer system 100’, in accordance with another example embodiment. The QCCD- based quantum computer system includes a PIC 500 that is disposed within and/or inside the cryogenic and/or vacuum chamber 40. Embodiments of quantum computing systems are contemplated that include one or more PICS 500 disposed external to and/or outwith the cryogenic and/or vacuum chamber 40 and one or more PICs 500 disposed within and/or inside the cryogenic and/or vacuum chamber. Moreover, in an example embodiment, the PIC 500 is formed on a substrate housing the confinement apparatus 50. In another example embodiment, the PIC 500 is formed on a substrate configured to be secured with respect to a substrate housing the confinement apparatus 50 or to be packaged with the substrate housing the confinement apparatus 50.

In various embodiments, the quantum computer system 100, 100’ comprises a computing entity 10 and a quantum computer 110, 110’. In various embodiments, a controller 30 of the quantum computer 110 may be in communication with the computing entity 10 via one or more wired and/or wireless networks 20. In various embodiments, the quantum computer 110, 110’ comprises the controller 30, a cryogenic and/or vacuum chamber 40 enclosing a confinement apparatus 50 (e.g., an ion trap and/or the like), one or more manipulation sources 70 (e.g., one or more laser systems), one or more beam delivery systems 68 configured to deliver manipulation signals generated by the manipulation sources 70 to locations defined at least in part by the confinement apparatus 50, and/or the like. In various embodiments, the confinement apparatus 50 is a confinement apparatus configured to confine one or more atoms, ions, molecules, quantum particles, and/or the like therein and the manipulation sources are configured to provide manipulation signals to one or more portions of the confinement apparatus 50 via optical paths defined by the beam delivery system(s) 68. In various embodiments, the manipulation signals may be used to initialize one or more objects (e.g., atoms, ions, molecules, quantum particles, and/or the like) into a qubit space, perform cooling operations, perform measurement operations, provide one or more gate signals, and/or the like. In various embodiments, the manipulation sources 70 comprise one or more laser systems configured to provide one or more manipulation signals (e.g., laser and/or optical beams and/or pulses) to one or more locations defined at least in part by the confinement apparatus 50 to enact one or more quantum gates (e.g., quantum logic gates) or other quantum operations. In various embodiments, the quantum gates may be one qubit gates, two qubit gates, and/or the like. In various embodiments, one or more gate signals may be provided to the one or more locations defined at least in part by the confinement apparatus 50 via beam delivery system(s) 68, which may include one or more PICs 500.

In various embodiments, a computing entity 10 is configured to allow a user to provide input to the quantum computer system 100, 100’ (e.g., via a user interface of the computing entity 10) and receive, view, and/or the like output from the quantum computer system 100, 100’. The computing entity 10 may be in communication with the controller 30 via one or more wired or wireless networks 20. For example, the computing entity 10 may be configured to provide quantum circuits to the controller 30 for execution by the quantum computer 110, 110’ and the controller 30 may provide the results of executing one or more quantum circuits to the computing entity 10.

In various embodiments, the controller 30 is configured to control the confinement apparatus 50, cooling and/or vacuum systems (not shown) controlling the temperature and pressure within the cryo and/or vacuum chamber 40, manipulation sources 70, and/or other components of the quantum computer 110, 110’ (e.g., an optical collection system configured for “reading” the output of the quantum computer). In various embodiments, the controller 30 is configured to control various components of the quantum computer 110, 110’ in accordance with executable instructions, command sets, and/or the like provided by the computing entity 10 and/or generated by the controller 30. In various embodiments, the controller 30 is configured to receive output from the quantum computer 110, 110’ (e.g., from an optical collection system) and provide the output and/or the result of processing the output to the computing entity 10.

### Example Coated PIC with Output Aperture

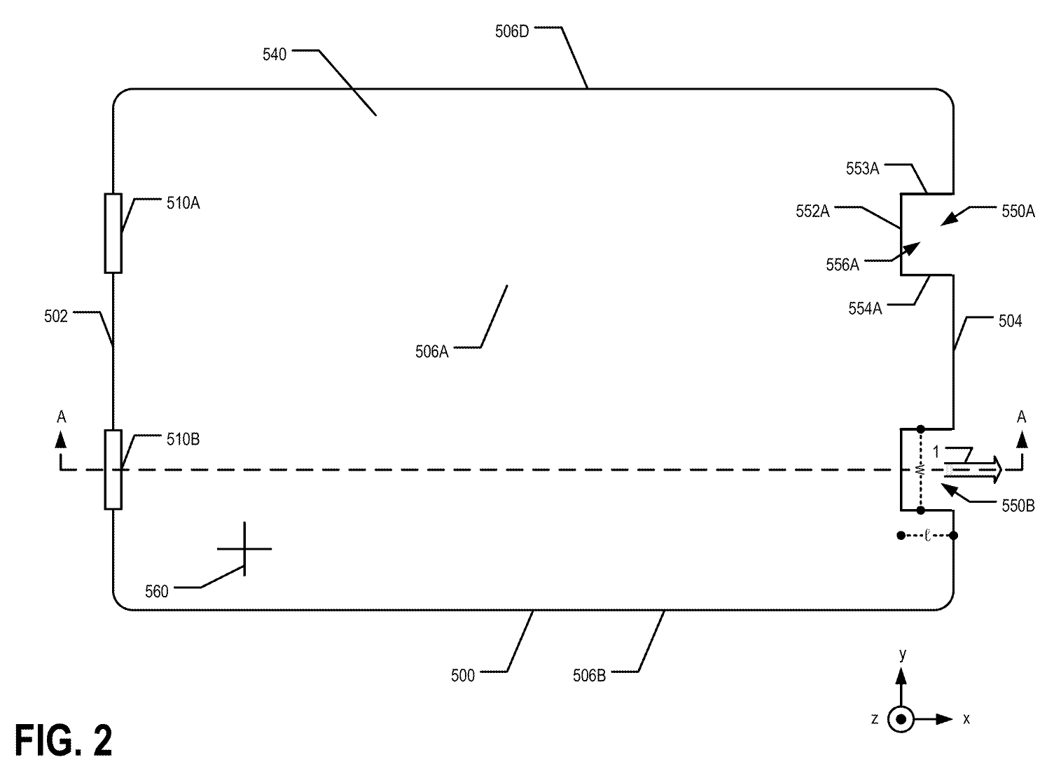

FIGS. 2, 3, 4, 5, and 6 provide various views of an example PIC 500 having a coating 540 with one or more etched and/or milled apertures 556 (e.g., 556A, 556B) formed through at least the coating. In the illustrated embodiment, the exterior surface 526 of the PIC body 520 is coated with a conformal coating 540.

In various embodiments, the PIC 500 comprises a PIC body 520. In various embodiments, the PIC body 520 may be formed on and/or from a substrate. The PIC body 520 includes an entrance side 502 and an exit side 504. One or more inputs 510 (e.g., 510A, 510B) are disposed on the entrance side 502. One or more outputs 550 (e.g., 550A, 550B) are disposed on the exit side 504. One or more waveguides 530 (e.g., 530A, 530B) optically couple the one or more inputs 510 to respective outputs of the one or more outputs 550. In various embodiments, at least one of the one or more outputs 550 includes a signal manipulation element. In various embodiments, the signal manipulation element is a grating (e.g., a grating coupler), a metasurface, a diffractive optical element (DOE), or other optical element configured to affect one or more optical properties (e.g., wavelength/frequency, polarization, phase delay, direction of propagation, focus location, and/or the like) of an optical beam emitted and/or output by the output 550.

In an example embodiment, the inputs 510 may be disposed on more than one side of the PIC body 520. For example, in some embodiments, the PIC body 520 includes more than one entrance side. In an example embodiment, the outputs 550 are disposed on more than one side of the PIC body 520. For example, in some embodiments, the PIC body 520 includes more than one exit side.

In various embodiments, the input(s) 510 are configured to couple laser and/or optical beams and/or pulses into respective waveguides 530. For example, laser and/or optical beams and/or pulses may be generated by a manipulation source 70 and provided to a respective input 510 via an optical fiber, bulk optics, waveguide, and/or the like. The input 510 couples the laser and/or optical beams and/or pulses into the respective waveguide 530.

In various embodiments, the waveguides 530 are formed in the PIC body 520. For example, in various embodiments, the PIC body 520 includes a first cladding 522 (e.g., a bottom oxide) and a second cladding 524 (e.g., a top oxide). The waveguides 530 are sandwiched between the first cladding 522 and the second cladding 524, in an example embodiment. For example, the first cladding 522 and second cladding 524 enclose the waveguides 530 in directions that are transverse to the direction of propagation of the laser and/or optical beams and/or pulses through the respective waveguides 530. In various embodiments, the PIC body 520, first cladding, 522, and/or second cladding 524 are made of and/or comprise glass, one or more oxides (e.g., SiO2, SiO2 TEOS), dielectric materials, air/vacuum, and/or the like. In various embodiments, the waveguides are formed from a waveguide material 534. For example, the waveguide material 534 may be a laser treated portion of the PIC body 520 and/or may be another material that is deposited or formed onto the second cladding 524 and then shaped (using photolithography, a masked etching, and/or the like) to form the waveguide 530 before the first cladding 522 is deposited or formed on to the second cladding 524 and the waveguides 530. In

various embodiments, the waveguide material 534 includes one or more of SiN, Si, Al2O3, TiO2, and/or another waveguide material. In various embodiments, the first cladding 522 and/or the second cladding 524 has a thickness in a range of 1 to 100 μm. In various embodiments, the first cladding 522 and/or the second cladding 524 has a thickness in a range of 1 to 50 μm. In an example embodiment, the first cladding 522 is thicker than the second cladding 524. For example, the first cladding may be the substrate the PIC is formed on, in an example embodiment.

In various embodiments, the waveguides 530 include and/or are optically coupled to one or more optical elements 532 (e.g., 532A, 532B). In various embodiments, the one or more optical elements 532 include beam splitters, beam combiners, modulators, filters, diffractive optical components, amplifiers, and/or the like. For example, the one or more optical elements 532 corresponding and/or coupled to a waveguide 530 is configured to condition a laser and/or optical beam and/or pulse as it propagates along the waveguide 530 from the respective input 510 to a respective output 550.

In various embodiments, a coating 540 is disposed and/or deposited on an exterior surface 526 of the PIC body 520. In various embodiments, the coating 540 is an optically opaque (at the wavelengths for which the waveguides 530 are configured to guide) and/or metal coating. For example, the coating may be made of and/or include Titanium Nitride (TiN), gold, aluminum, and/or other materials, metals, and/or alloys that are electrically conductive in the operating conditions of the PIC 500 and/or optically opaque with respect to the wavelengths for which the waveguides 530 are configured to guide. For example, the coating 540 of a PIC 500 that is configured to operate within the cryogenic and/or vacuum chamber 40 may be different from that of a PIC that is configured to operate outside of the cryogenic and/or vacuum chamber 40 given the different temperatures and/or pressures of the respective operating conditions.

In various embodiments, the coating 540 is a conformal coating that is applied and/or deposited on the exterior surface 526 of the PIC body 520 after the formation of the waveguides 530 and any optical elements 532 of the PIC 500 but prior to the etching of the etched and/or milled apertures 556. In various embodiments, the PIC body 520 is encased and/or enclosed in the coating 540 other than the inputs 510. In an example embodiment, the coating 540 is only applied to the exit side 504 of the PIC body 520. In an example embodiment, the coating 540 is applied to the exterior surface 526 of the exit side 504 of the PIC body 520 and the exterior surface 526 of one or more lateral sides 506 (e.g., 506A, 506B, 506C, 506D) of the PIC body 520. As used herein, the lateral sides 506 of the PIC body 520 are any sides of the PIC body other than the entrance side(s) 502 and the exit side(s) 504. In various embodiments, the coating 540 is applied to the exterior surface of the one or more entrance side(s) 502. The coating 540 is etched and/or milled to form the etched and/or milled aperture(s) 556 therethrough. In an example embodiment, an etched and/or milled aperture 556 corresponds to and/or is optically aligned with a input 510 or an output 550.

In various embodiments, the coating 540 acts to block, absorb, reflect, and/or attenuate light within the PIC body 520 that was not coupled into a waveguide 530 or that was scattered out of a waveguide 530. For example, the coating 540 may block, absorb, reflect, and/or attenuate any light trying to exit the PIC body 520 that is not part of a guided mode of a laser and/or optical beam and/or pulse propagating in the emission direction 1 of a respective output. In an example embodiment, the coating 540 extends out from the exterior surface of the PIC body 520 by a thickness that is at least one absorption depth of light of the wavelength(s) for which the waveguides 530 are designed to guide in the material of the coating 540. In an example embodiment, the coating 540 extends out from the exterior surface of the PIC body 520 by a thickness in a range of 15 nm to 1 μm.

The PIC 500 further comprises one or more etched and/or milled apertures 556 that are etched at least through the coating 540 and possibly into the PIC body 520. For example, each etched and/or milled aperture 556 of the one or more etched and/or milled apertures is etched through the coating 540 and, possibly, into the PIC body 520 to form and/or define a first sidewall 553 (e.g., 553A, 553B), a second sidewall 554 (e.g., 554A, 554B), and a back wall 552 (e.g., 552A, 552B). The first sidewall 553 and the second sidewall 554 extending out from opposite edges of the back wall 552 (e.g., in the emission direction 1 of the output 550 corresponding to the etched and/or milled aperture 556). The output 550 corresponding to the etched and/or milled aperture 556 is disposed on the back wall 552 of etched and/or milled aperture 556. In an example embodiment, an etched and/or milled aperture 556 corresponds to an input 510 and the input 510 is disposed on the back wall 552 of the etched and/or milled aperture 556.

In various embodiments, the etched and/or milled aperture 556 is a conformal aperture. For example, in various embodiments, the etched and/or milled aperture 556 is centered on and concentric with the output 550 of the waveguide 530. In an example embodiment, the etched and/or milled aperture is in contact with the PIC structure (e.g., the waveguide 530, and/or the like).

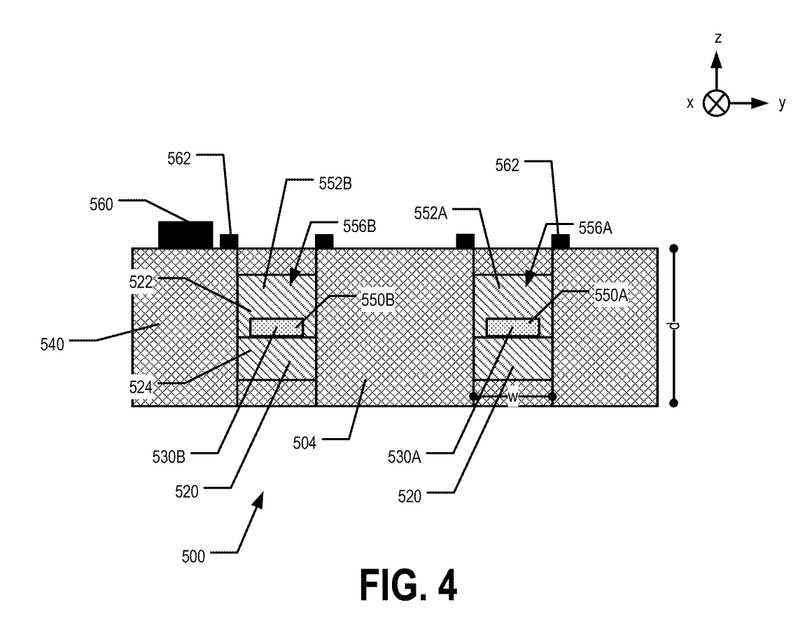

In various embodiments, a width w of the etched and/or milled aperture 556 is defined in a direction that is (at least locally) parallel to a length of the exit side 504 of the PIC 500 (the y-direction as illustrated in FIGS. 2 and 4) and transverse and/or perpendicular to the emission direction 1 of the output 550 (the x-direction as illustrated in FIGS. 2 and 4). In various embodiments, a span s of the etched and/or milled aperture 556 is defined in a direction that is (at least locally) parallel to a height of the exit side 504 of the PIC 500 (the z-direction as illustrated in FIG. 4) and transverse and/or perpendicular to the emission direction 1 of the output 550 (the x-direction as illustrated in FIG. 2). As should be understood, the emission direction 1 of the output 550 is the direction in which laser and/or optical beams and/or pulses propagate when exiting the output 550. Thus, the width w is a distance between two opposite or opposing sidewalls of the aperture and the span s is a distance between a different two opposite or opposing sidewalls of the aperture. For example, the width w is measured across the aperture 556 in a first direction and the span s is measured across the aperture 556 in a second direction that is generally orthogonal to the first direction.

In an example embodiment, the width w of the etched and/or milled aperture 556 is the width of the back wall 552. In various embodiments, the width w and/or span s of the etched and/or milled aperture 556 is larger than an expected mode field diameter of a laser and/or optical beam and/or pulse exiting the respective output. For example, the mode field diameter (MFD) of a laser and/or optical beam and/or pulse defines a surface through which 90 % of the power of the laser and/or optical beam and/or pulse passes through as the laser and/or optical beam and/or pulse exits the output 550. In various embodiments, the width w and/or span s is larger than the MFD but smaller than twice the MFD. In various embodiments, the width w and/or span s is larger than the MFD but smaller than 1.5 times the MFD. In various embodiments, the width w and/or span s is in a (inclusive) range of 5 to 40 μm. In various embodiments, the width w and/or span s is in a (inclusive) range of 15 to 30 μm.

In an example embodiment, the MFD defines the lower limit of a range from which the width w may be selected. In an example embodiment, the upper limit of a range from which the width w and/or span s may be selected is determined by determining a desired and/or maximum allowed spot size of the laser and/or optical beam and/or pulse on the image plane (e.g., at a respective location defined at least in part by the confinement apparatus 50) and then tracing that spot size backward through the portion of the beam delivery system disposed between the output 550 of the PIC 500 and the image plane (e.g., the respective location). By tracing changes in the spot size backward from the image plane through any magnification, focusing, and/or defocusing effects of any optical elements of the beam delivery system 68 disposed between the output 550 of the PIC 500 and the image plane, an MFD at the output 550 can be determined. In various embodiments, the MFD at the output 550 defines the lower limit of the range from which the width w may be selected.

In various embodiments, a length ℓ of the etched and/or milled aperture 556 is defined in a direction that is parallel to the emission direction 1 of the output 550. In an example embodiment, the length ℓ is such that the etched and/or milled aperture 556 only extends through the coating 540 (e.g., the PIC body 520 itself is not etched and/or milled). In an example embodiment, the length ℓ is such that the etched and/or milled aperture 556 extends into the PIC body 520. For example, in various embodiments, the length ℓ is determined, designed, and/or configured to be equal to or larger than the thickness of the coating 540.

In various embodiments, the length e is determined, designed, and/or configured based on requirements of mechanical processes used to form the etched and/or milled aperture 556. For example, the length l is determined, designed, and/or configured to be greater than the dicing chip-out score (e.g., approximately 1-100 µm) and/or polishing scores (e.g., 0.1-1 µm).

In various embodiments, the length ℓ is determined, designed, and/or configured based on requirements of mechanical processes used to form the etched and/or milled aperture 556. For example, the length ℓ is determined, designed, and/or configured to be greater than the dicing chip-out score (e.g., approximately 1-100 μm) and/or polishing scores (e.g., 0.1-1 μm). In various embodiments, the length ℓ is determined, designed, and/or configured based on the facet angle of the exit side 504 of the PIC body before the forming of the etched and/or milled aperture and how much material needs to be removed (e.g., from the PIC body 520) to correct the facet angle. As used herein, the facet angle is the angle between a plane that is perpendicular to the emission direction 1 of waveguide and a plane defined by the exit side 504 of the PIC body 520. In an example embodiment, the facet angle φ is selected to prevent Fresnel reflections. In an example embodiment, the facet angle φ is selected to deliver beams and/or pulses to an angled view port. In various embodiments, the facet angle φ is within a (inclusive) range of -10 to 10 degrees; however, angles outside of this range may be used in various embodiments, as appropriate for the application. In various embodiments, the facet angle φ is within a (inclusive) range of -1 to 1 degrees. In an example embodiment, the facet angle φ is within a (inclusive) range of -0.5 to 0.5 degrees. In various embodiments, the etching and/or milling of the aperture 556 is performed in a manner to provide a desired facet angle φ.

In various embodiments, the length ℓ is determined, designed, and/or configured so as to prevent the formation of diffraction patterns from the laser and/or optical beam and/or pulse exiting the output 550 interacting with the sidewalls 553, 554. In various embodiments, the length ℓ is determined, designed, and/or configured so as to absorb, block, reflect, and/or attenuate light exiting PIC 500 (e.g., via first sidewall 553, second sidewall 554, back wall 552, output 550) that is not propagating in a direction parallel to the emission direction 1. For example, the length ℓ may be determined, designed, and/or configured to prevent at least a portion of the light exiting the PIC 500 into the etched and/or milled aperture 556 that is propagating in a direction transverse to the emission direction 1 from exiting the etched and/or milled aperture 556 toward the confinement apparatus 50. For example, at least a portion of the light exiting the PIC 500 into the etched and/or milled aperture 556 that is propagating in a direction transverse to the emission direction 1 exits the aperture by being absorbed by the PIC body 520 and/or coating 540, in an example embodiment. In various embodiments, the length ℓ is within a (inclusive) range of 1 to 20 μm. In an example embodiment, the length ℓ is in a (inclusive) range of 1 to 5 μm.

FIG. 6 provides a zoomed in view of a portion of an etched and/or milled aperture 556 including a portion of the first sidewall 553B. In the illustrated embodiment, the first sidewall 553B is not perpendicular to the back wall 552B. For example, a sidewall angle θ is formed between the first sidewall 553B and a normal 558 to the back wall 552B. In various embodiments, the second sidewall 554B forms an equivalent sidewall angle θ with a respective normal 558 to the back wall 552B. For example, the distance between the first sidewall 553B and the second sidewall 554B may increase as a distance from the back wall 552B increases in the emission direction 1. In various embodiments, the sidewall angle θ is within a (inclusive) range of -10 to 10 degrees; however, angles outside of this range may be used in various embodiments, as appropriate for the application. In various embodiments, the sidewall angle θ is within a (inclusive) range of -1 to 1 degrees. In an example embodiment, the sidewall angle θ is within a (inclusive) range of -0.5 to 0.5 degrees.

In various embodiments, as shown in FIG. 6, the edges of the sidewalls 553, 554 are rounded and/or beveled as a result of redeposition of material from the etching and/or milling process. In various embodiments, the width w of the aperture 556 is determined and/or selected taking into account the redeposition on the sidewalls 553, 554 of the aperture.

In various embodiments, the etched and/or milled apertures 556 are disposed based on the location of the respective outputs 550 the PIC 500. As should be understood, the locations of the output of the PIC 500 are determined based on the locations defined at least in part by the confinement apparatus 50 to which the PIC is configured to provide respective laser and/or optical beams and/or pulses and any elements of the beam delivery system 68 disposed between the output the locations defined at least in part by the confinement apparatus 50 to which the PIC is configured to provide respective laser and/or optical beams and/or pulses. In various embodiments, the locations of the etched and/or milled apertures 556 are defined by the lithographic processes that define the respective outputs 550 of the PIC 500.

In an example embodiment, an adhesion layer 545 is disposed between the PIC body 520 and the coating 540. For example, if the material of the coating 540 does not naturally adhere to the material of the PIC body 520, an adhesion layer 545 may be applied and/or deposited on the PIC body 520 and then the coating 540 is applied and/or deposited thereon. For example, the adhesion layer 545 comprises a thin layer (e.g., thinner than the coating 540) of material that naturally adheres to both the material of the PIC body 520 and the material of the coating 540. For example, in an example embodiment where the PIC body 520 comprises glass (e.g., SiO2) formed on a Si substrate and the coating 540 comprises gold, an adhesion layer 545 comprising titanium, chromium, aluminum or another metal that adheres to glass may be used to improve the adhesion of the coating 540 to the PIC body 520.

In various embodiments, the PIC 500 comprises one or more alignment features 560. For example, the alignment feature(s) 560 are formed on the PIC body 520 prior to the depositing of the coating 540 thereon. The coating 540 is a conformal coating and the alignment features 560 are sized to be detectable once the coating 540 has been applied and/or deposited onto the PIC body 520. In various embodiments, the alignment features 560 are configured for use in aligning the PIC 500 for the etching of the etched and/or milled apertures 556, for use in an atomic, quantum, or other system (e.g., quantum computing system 100, 100’), for use in a testing environment, and/or the like.

In various embodiments, the PIC 500 comprises one or more etch placement features 562. In various embodiments, the etch placement features 562 may be alignment features of the one or more alignment features 560. In various embodiments, an etch placement feature 562 is configured to guide the etching of at least a portion of an etched and/or milled aperture 556. For example, an etch placement features 562 may be used as an etching guide when performing an etch that generates, forms, and/or defines a sidewall 553, 554 of an etched and/or milled aperture 556.

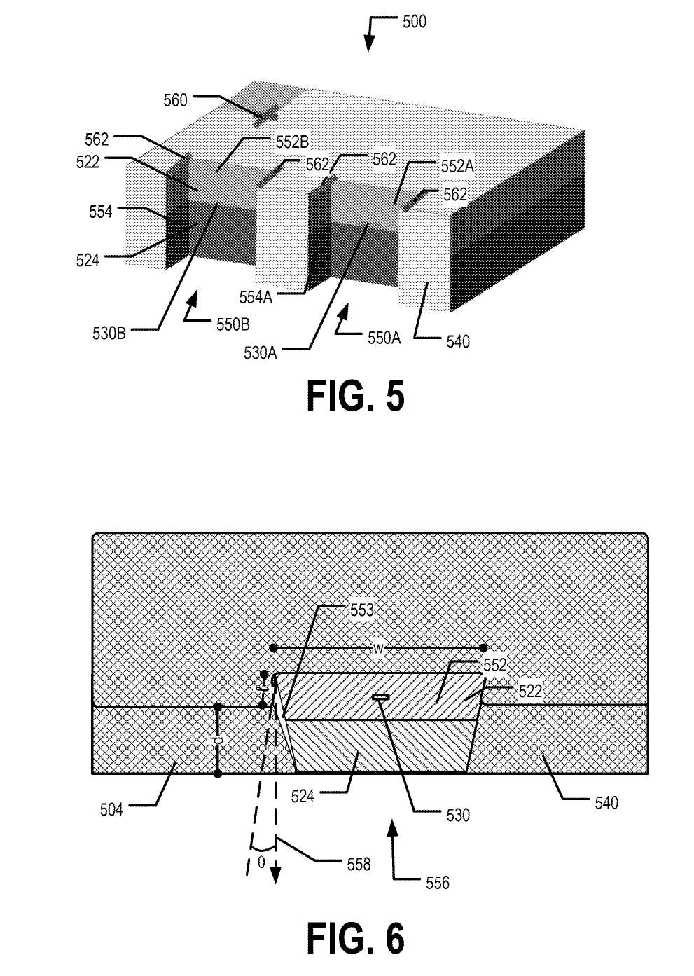

In various embodiments, the alignment feature(s) 560 and/or etch placement features 562 are topographical features such as respective step ups, step down, ridges, multi-dimensional trenches or ridges (e.g., a plus-sign or X as illustrated in FIGS. 2 and 5), and/or the like. In various embodiments, the alignment feature(s) and/or etch placement features 562 have a height, depth, and/or thickness (with respect to the exterior surface 526 of the PIC body 520) in a range of 100 nm to 1 μm. For example, the height, depth, and/or thickness of the alignment feature(s) 560 and/or etch placement features 562 are configured to ensure the alignment feature(s) 560 and/or etch placement features 562 are detectable after the coating 540 is applied and/or deposited onto the PIC body 520.

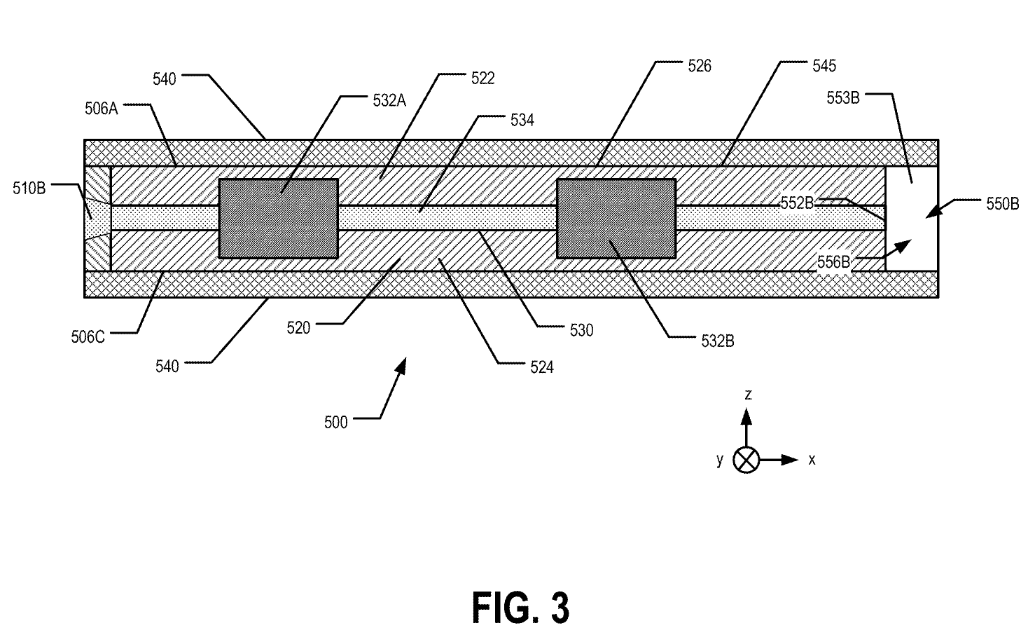

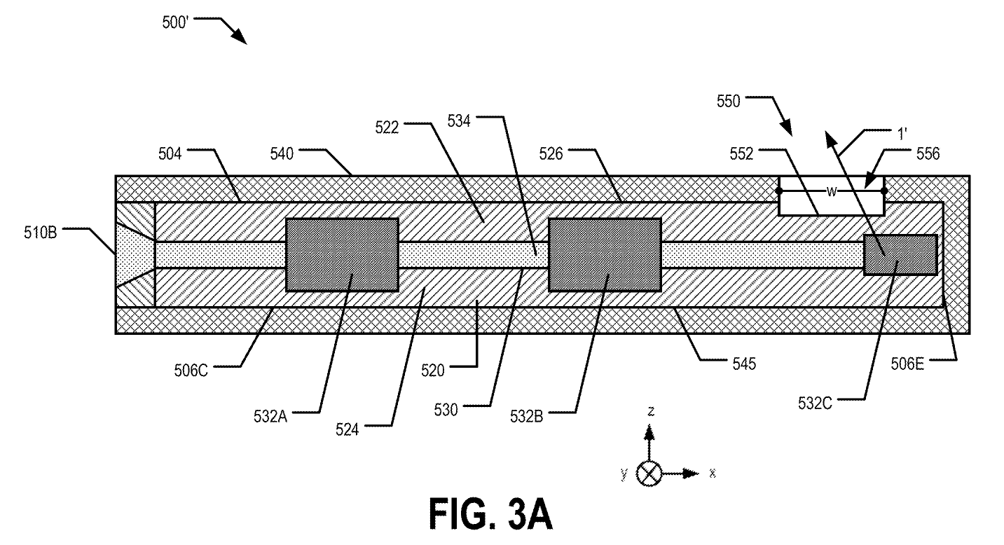

In various embodiments, an exit side 504 of PIC 500’ is parallel to and/or not perpendicular to a propagation direction of the waveguide(s) 530. For example, FIG. 3A shows a cross-sectional view of a PIC 500’ that is similar to the PIC 500 shown in FIG. 3. The PIC 500’ includes a third optical element 532C that is a coupler (e.g., a grating coupler) that couples light out of the waveguide such that the light propagates in the emission direction 1’. For example, the coupler directs light that propagated through the waveguide 530 to the coupler (the third optical element 532C) out of the waveguide 530 in the emission direction 1’ such that the light exits the PIC 500’ via output 550. For example, the light coupled out of the waveguide 530 by the coupler (optical element 532C) propagates (e.g., in a free mode) through a portion of the cladding 522 and out through the back wall 552 and through the aperture 556 of the output 550.

In various embodiments, a width w (measured in the x-direction in FIG. 3A) and a span s (measured in the y-direction in FIG. 3A) of the etched and/or milled aperture 556 are each larger than an expected mode field diameter of a laser and/or optical beam and/or pulse exiting the respective output 550. For example, any measurement or distance between opposing sidewalls (e.g., 553, 554) of the aperture 556 is larger than an expected mode field diameter of a laser and/or optical beam and/or pulse exiting the respective output 550, in an example embodiment.

In various embodiments, a PIC 500 may include outputs in more than one exit sides. For example, the cross-sectional view of PIC 500 shown in FIG. 3 and the cross-sectional view of PIC 500’ shown in FIG. 3A may cross-sections of the same PIC taken at different locations in the y-direction of the PIC.

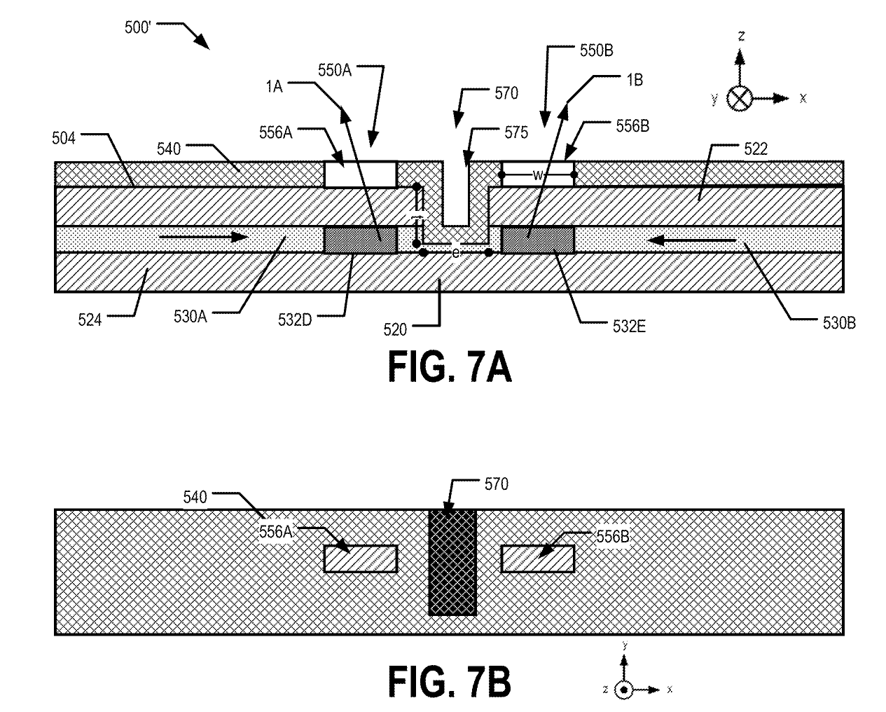

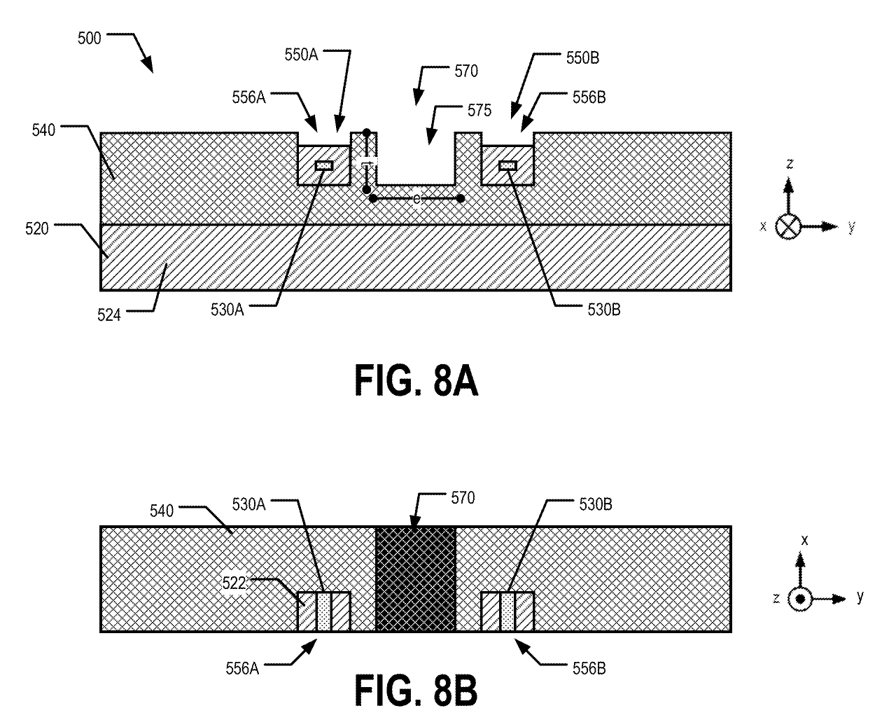

In various embodiments, a PIC 500, 500’ includes one or more trench baffles 570, as shown in FIGS. 7A, 7B, 8A, and 8B. For example, FIGS. 7A and 7B illustrates an example PIC 500’ including a trench baffle 570 disposed between adjacent outputs 550A, 550B and having an exit side 504 that is parallel to and/or not perpendicular to a propagation direction of the waveguide(s) 530. For example, a portion of a waveguide layer may be split into two waveguides 530A, 530B by a trench 575 etched through the first cladding 522, for example, and at least partially through the waveguide layer. The edges (e.g., bottom and sidewalls) of the trench 575 are coated with the coating 540 so as to form a trench baffle 570 that prevents light from the first waveguide 530A from interacting with light from the second waveguide 530B within the PIC 500’. For example, the trench baffle 570 prevents crosstalk between the optical channel corresponding to and/or including waveguide 530A and the optical channel corresponding to and/or including waveguide 530B.

In the illustrated embodiment, an optical elements 532D is optically coupled to the first waveguide 530A and another optical element 532E is optically coupled to the second waveguide 530B. In various embodiments, the optical elements 532D, 532E are couplers (e.g., grating couplers) configured to couple light out of the respective waveguide 530A, 530B such that the light propagates in a respective emission direction 1A, 1B. For example, the couplers direct light that propagated through the respective waveguides 530A, 530B out of the respective waveguides 530A, 530B in the respective emission directions 1A, 1B such that the light exits the PIC 500’ via a respective output 550A, 550B. For example, the light coupled out of the waveguide 530A by the coupler (optical element 532D) propagates (e.g., in a free mode) through a portion of the cladding 522 and out through the back wall 552 and through the aperture 556A of the output 550A. In another example, the light coupled out of the waveguide 530B by the coupler (optical element 532E) propagates (e.g., in a free mode) through a portion of the cladding 522 and out through the aperture 556B of the output 550B.

FIGS. 8A and 8B illustrate an exit end view and a top view of a PIC 500 having a trench baffle 570 disposed between two adjacent outputs 550A, 550B. The exit side 504 of the PIC 500 is transverse to the propagation direction defined by the waveguides 530A, 530B. In an example embodiment, the trench baffle 570 extends along at least a portion of the lengths of the waveguides 530A, 530B. For example, the trench baffle 570 may extend between the parallel waveguides 530A, 530B for all and/or a portion of the length of the waveguides 530A, 530B. In various embodiments, the trench baffle 570 prevents crosstalk from occurring between the parallel waveguides 530A, 530B.

In various embodiments, the trench baffle 570 is formed of a trench 575 that has been conformally coated with the coating 540. For example, a trench 575 may be etched into the PIC body 520 extending a depth t into the PIC body 520 and having a width e. For example, the trench 575 may be etched into the PIC body 520 to define trench walls having a height t and a trench bottom having a width e. The trench walls and the trench bottom extend the length of the trench. In various embodiments, the depth t of a trench 575 is in a range of 0.5 to 100 μm (inclusive). For example, in an example embodiment, the depth t of the trenches 575 is in a range of 1 to 20 μm (inclusive). In various embodiments, the width e of a trench 575 is in a range of 0.5 to 100 μm (inclusive). In an example embodiment, the coating 540 is not applied to the trench 575 and the trench 575 itself acts as the trench baffle 570. In another example embodiment, the trench 575 is filled with coating 540 and/or another material having a high optical extinction coefficient and/or absorption coefficient.

### Example Method of Manufacturing a Coated PIC with an Output Aperture

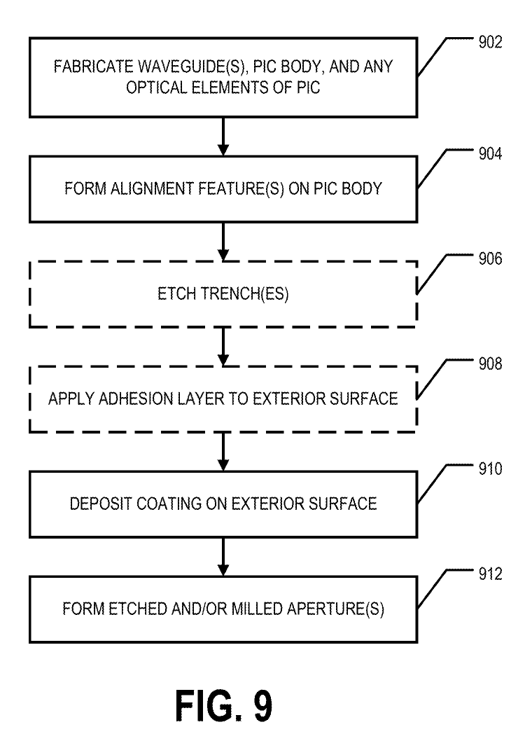

FIG. 9 provides a flowchart illustrating various processes, procedures, operations, and/or the like for fabricating a PIC 500. Starting at step 902, the PIC body 520, waveguides 530, and any optical elements 532 of the waveguides are formed and/or fabricated. For example, in an example embodiment, a second cladding 524 is formed and/or deposited (e.g., on a substrate and/or the like), one or more waveguides 530 and/or optical elements 532 are formed on the second cladding 524. A first cladding 522 is then formed and/or deposited so as, with the second cladding 524, enclose the waveguides 530, and possibly optical elements 532. The resulting PIC body 520 includes the waveguides 530 defined and/or formed therein. In various embodiments, the first cladding 522 and/or second cladding 524 is thermally grown or deposited via at least one of a PECVD, sputtering, or evaporation deposition technique. In various embodiments, one or more layers of the waveguide material 534, from which the waveguides 530 are formed and/or patterned, is deposited using PECVD, CVD, sputtering, ALD, evaporation deposition, and/or the like.

In another example embodiment, a PIC body 520 is formed of, for example, a cladding material. One or more waveguides 530 and/or optical elements 532 are formed and/or implanted therein to provide a PIC body 520 having waveguides 530 defined and/or formed therein. As should be understood by one of ordinary skill in the art, the PIC body 520, waveguides 530, and any optical elements 532 may be formed and/or fabricated using various techniques, as appropriate for the application.

In various embodiments, fabricating the PIC body 520 includes performing a dice and edge polish step. For example, the exit side(s) 504, entrance side 502, and/or one or more lateral sides 506 of the PIC body 520 may be polished (e.g., using mechanical polishing, chemical- mechanical polishing, and/or the like).

At step 904, the one or more alignment features 560 and/or etch placement features 562 are formed on the PIC body 520. For example, the PIC body 520 may be etched to form one or more alignment features 560 and/or etch placement features 562. For example, material may be deposited onto the PIC body 520 to form one or more alignment features 560 and/or etch placement features 562. For example, a layer of material may be deposited onto a portion of the exterior surface 526 of the PIC body 520 and then etched using photolithography and/or masked etching to form alignment features 560 and/or etch placement features 562. In an example embodiment, the alignment features 560 and/or etch placement features 562 are formed using a lift-off or damascene process.

At step 906, one or more trenches 575 are etched into the PIC body 520. For example, trenches 575 may be etched between parallel waveguides and/or parallel optical paths defined through respective portions of the PIC body 520. In various embodiments, the trenches 575 are etched with a depth t and a width e. In various embodiments, the depth t of a trench 575 is in a range of 0.5 to 100 μm. For example, in an example embodiment, the depth t of the trenches 575 is in a range of 1 to 20 μm. In various embodiments, the width e of a trench 575 is in a range of 0.5 to 100 μm.

In various embodiments, steps 904 and 906 may be done simultaneously. For example, a single lithographic and/or mask and etch step may be used to form the trenches and the alignment features. In another example, steps 904 and 906 may be performed at separate times. In an example embodiment, step 906 is performed prior to step 904.

At step 908, if required or desired, an adhesion layer 545 is applied and/or deposited onto the exterior surface 526 of the PIC body 520. In various embodiments, the adhesion layer 545 is applied and/or deposited onto the entire exterior surface 526 of the PIC body 520. If a trench 575 is present, the adhesion layer 545 is also applied to the edges or walls of the trench 575.

At step 910, the coating 540 is applied and/or deposited onto the exterior surface 526 (and/or the adhesion layer 545) of the PIC body 520. In an example embodiment, the deposition of the coating 540 is conformal. For example, the coating is applied and/or deposited on to one or more surfaces of the PIC body 520 conformally.

For example, a metallic and/or optically opaque (at the wavelengths the waveguides are configured to guide) coating is applied and/or deposited onto the exterior surface 526 (and/or the adhesion layer 545) of the PIC body 520. In various embodiments, the coating 540 is applied and/or deposited onto the entire exterior surface 526 (or adhesion layer 545) of the PIC body 520. In various embodiments, the coating 540 is deposited using a conformal deposition technique. For example, in an example embodiment, the coating is applied and/or deposited using a sputtered deposition technique, an atomic layer deposition (ALD) technique, and/or an evaporation deposition technique. In various embodiments, the coating 540 is deposited to a thickness (e.g., extending out from the exterior surface 526 of the PIC body 520) that is at least the absorption depth of light of the wavelength(s) for which the waveguides 530 are designed to guide in the material of the coating 540. In an example embodiment, the coating 540 is deposited to a thickness (e.g., extending out from the exterior surface 526 of the PIC body 520) that is in a range of 100 nm to 1 μm.

In an example embodiment where one or more trenches have been etched into the PIC body 520, the conformal deposition of the coating 540 also causes the edges or walls of the trenches 575 to be coated to provide respective trench baffles 570.

At step 912, one or more etched and/or milled apertures 556 are formed. For example, the PIC 500 (e.g., PIC body 520 and coating 540) are etched to form the etched and/or milled apertures 556. In various embodiments, the etched and/or milled apertures 556 are etched to form and/or define the respective first sidewalls 553, respective second sidewalls 554, and respective back walls 552. In an example embodiment, the etched and/or milled apertures 556 are formed and/or etched using a focused ion beam (FIB) etching technique. For example, a beam of argon may be used to mill out the etched and/or milled apertures 556. In an example embodiment, the etched and/or milled apertures 556 are formed using a lift-off technique. In an example embodiment, where a lift-off technique is used to form the etched and/or milled apertures 556, the length ℓ of the aperture may be substantially equal to the thickness of the coating 540 (e.g., the etched and/or milled aperture 556 may not extend into the PIC body 520). In various embodiments, the locations at which the etched and/or milled apertures 556 are etched is determined at least in part based on etch placement features 562.

In various embodiments, the etched and/or milled apertures 556 are etched to have a width w is in a (inclusive) range of 5 to 40 μm. In various embodiments, the etched and/or milled apertures 556 are etched to have a width is in a (inclusive) range of 15 to 30 μm. In various embodiments, the etched and/or milled apertures 556 are etched to have a length ℓ is within a (inclusive) range of 1 to 20 μm. In an example embodiment, the etched and/or milled apertures 556 are etched to have a length ℓ is in a (inclusive) range of 1 to 5 μm. In an example embodiment, width w is larger than an expected mode field diameter of an optical beam expected to be exiting the respective output 550.

In an example embodiment, the etched and/or milled apertures 556 are etched to have a span s (e.g., in the z-direction as illustrated in FIGS. 3 & 4 or in the y-direction as illustrated in FIG. 3A) that is substantially the same or less than the depth d of the PIC 500 having the coating 540 applied thereto. In various embodiments, the length of the etched and/or milled apertures 556 is larger than an expected mode field diameter of an optical beam expected to be exiting the respective output 550.

In various embodiments, the etched and/or milled aperture 556 is etched such that the respective first sidewalls 553, second sidewalls 554, and back walls 552 are smooth. In various embodiments, the etched and/or milled aperture 556 is etched such that the respective first sidewalls 553 and second sidewalls 554 are substantially planar. In various embodiments, the etched and/or milled aperture 556 is etched such that the back wall 552 is one of planar, concave, or convex, as appropriate for the application.

In various embodiments, openings through the coating 540 (and adhesion layer 545 if one is present) corresponding to the one or more inputs 510 may also be etched and/or formed through shadow masking. For example, openings may be etched through the coating 540 (and adhesion layer 545 if one is present) to allow laser and/or optical beams and/or pulses into respective inputs 510 of the PIC 500.

In various embodiments, the apertures 556 are at least partially formed through techniques other than etching or milling. For example, in an example embodiment, the apertures 556 are formed through shadow masking. For example, in such an embodiment, prior to the depositing of the coating on the exterior surface of the PIC body 520, masks are applied to the locations on the exit side 504 where the apertures 556 are to be formed. When the coating 540 is deposited on the exterior surface of the PIC body 520 (e.g., on the exterior surface of the exit side 504), the coating does not adhere to the masks and the apertures 556 through the coating 540 are formed.

### Technical Advantages

In conventional PICs, some of the light provided to a PIC input may not be coupled into the guided mode or may be scattered out of the guided mode as the light travels through the PIC. For example, some of the light being provided to an input of the PIC may not be coupled into a waveguide via the input. In another example, some of the light propagating through a waveguide of the PIC may be scattered by the roughness of the edges of the waveguide. Some of the uncoupled and/or scattered light may propagate out through the exit side of the PIC. This unguided light may cause light intensity away from the main peak position(s) in the image plane. For example, the uncoupled and/or scattered light may interfere with the array of laser and/or optical beams provided via the outputs of the PIC, resulting in increased scattering of light out of laser and/or optical beams of the array. For example, in some applications it is desired to have 60-70 dB of extinction between adjacent laser and/or optical beams output by the PIC. However, in conventional PICs, the extinction between adjacent laser and/or optical beams output by the PIC is at best 50 dB. Therefore, technical problems regarding controlling, preventing, and/or removing the uncoupled and/or scattered light from the output of the PIC.

Various embodiments provide technical solutions to these technical problems. For example, in various embodiments, one or more outputs of the PIC are disposed within and/or correspond to a respective etched and/or milled aperture formed into the PIC body. In various embodiments, a coating, such as a metallic or optically opaque (at the wavelengths the waveguides of the PIC are configured to guide) coating is deposited, applied, and/or disposed on the exterior surface of the PIC body. The etched and/or milled apertures extend through the coating into the PIC body to provide an optical aperture through the coating. The coating prevents light from exiting the exit side of the PIC between the etched and/or milled apertures. The geometry of the etched and/or milled apertures prevents light that is traveling in a direction transverse and/or not substantially parallel to the emission direction of the respective outputs of the PIC to be blocked or attenuated. Thus, light traveling in a direction transverse and/or not substantially parallel to the emission direction of the respective outputs of the PIC is prevented from reaching the image plane(s) of the respective outputs. As a result, the extinction between adjacent laser and/or optical beams output by the PIC is able to reach 60 dB or more. Thus, embodiments disclosed herein provide technical improvements to the technical fields of PICs and beam delivery systems.

### Exemplary Controller

In various embodiments, a quantum computer 110, 110’ comprises a controller 30 configured to control various elements of the quantum computer 110, 110’. In various embodiments, a controller 30 may be configured to cause a quantum computer 110, 110’ to perform various operations (e.g., computing operations such as gate operations, cooling operations, transport operations, qubit interaction operations, qubit measurement operations, leakage suppression operations, and/or the like). For example, the controller 30 may be configured to cause manipulation sources 70 to provide manipulation signals to objects (e.g., atoms, ions, molecules, quantum particles, and/or the like) confined and/or trapped within the confinement apparatus 50. For example, the controller 30 may be configured to cause the manipulation sources 70 to provide one or more laser and/or optical beams and/or pulses to one or more locations defined at least in part by the confinement apparatus 50 so as to enact, for example, one or more quantum gates, read a quantum state of an object, perform sympathetic laser cooling of an object, and/or the like. In various embodiments, the controller 30 may be configured to control a cryogenic system and/or vacuum system controlling the temperature and pressure within the cryogenic and/or vacuum chamber 40, manipulation sources 70, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more objects confined by the confinement apparatus 50.

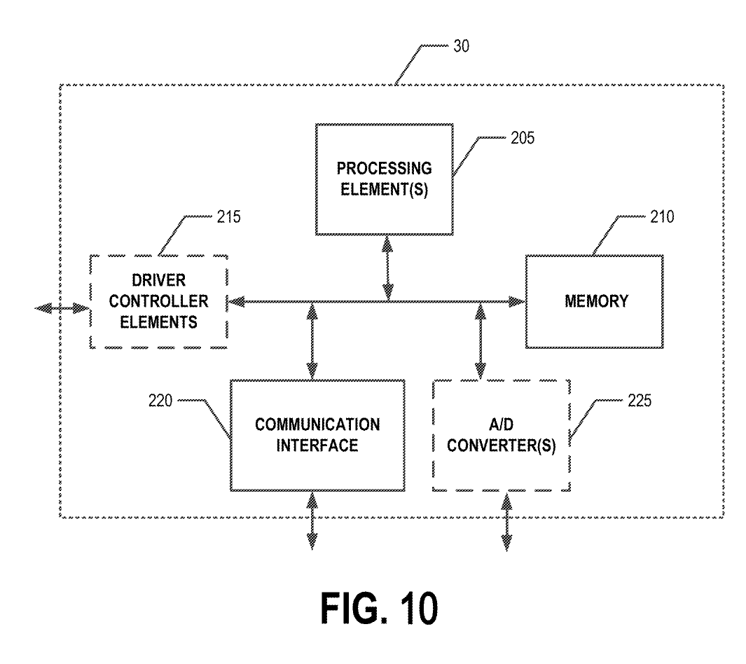

As shown in FIG. 10, in various embodiments, the controller 30 may comprise various controller elements including processing element(s) 205, memory 210, driver controller elements 215, a communication interface 220, analog-digital converter 225, and/or the like. For example, the processing element(s) 205 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products. In an example embodiment, the processing element(s) 205 of the controller 30 comprises a clock and/or is in communication with a clock.

For example, the memory 210 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 210 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 210 (e.g., by a processing element(s) 205) causes the controller 30 to perform one or more steps, operations, processes, procedures and/or the like described herein for tracking the phase of an atomic object within an atomic system and causing the adjustment of the phase of one or more manipulation sources and/or signal(s) generated thereby.

In various embodiments, the driver controller elements 215 may include one or more drivers and/or controller elements each configured to control one or more drivers. In various embodiments, the driver controller elements 215 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element(s) 205). In various embodiments, the driver controller elements 215 may enable the controller 30 to operate a servo, manipulation sources 70 (e.g., laser systems), vacuum and/or cryogenic systems, and/or the like. In various embodiments, the drivers may be laser drivers; microwave drivers; vacuum component drivers; cryogenic and/or vacuum system component drivers; current drivers, and/or the like. For example, the drivers and/or driver controllers may be configured to cause a magnetic field generation device (e.g., comprising circuitry coupled to a voltage source (e.g., a current driver or voltage driver), permanent magnet(s), and/or a combination thereof) to generate a magnetic field having a particular direction and magnitude at one or more regions of and/or locations defined at least in part by the confinement apparatus 50. In various embodiments, a plurality of regions of and/or location defined at least in part by the confinement apparatus 50 (e.g., confinement apparatus zones) may be defined. In various embodiments, the controller 30 comprises means for communicating and/or receiving signals from one or more optical receiver components such as cameras, MEMs cameras, CCD cameras, photodiodes, photomultiplier tubes, and/or the like. For example, the controller 30 may comprise one or more analog-digital converter element(s) 225 configured to receive signals from one or more optical receiver components, calibration sensors, and/or the like.

In various embodiments, the controller 30 may comprise a communication interface 220 for interfacing and/or communicating with a computing entity 10. For example, the controller 30 may comprise a communication interface 220 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

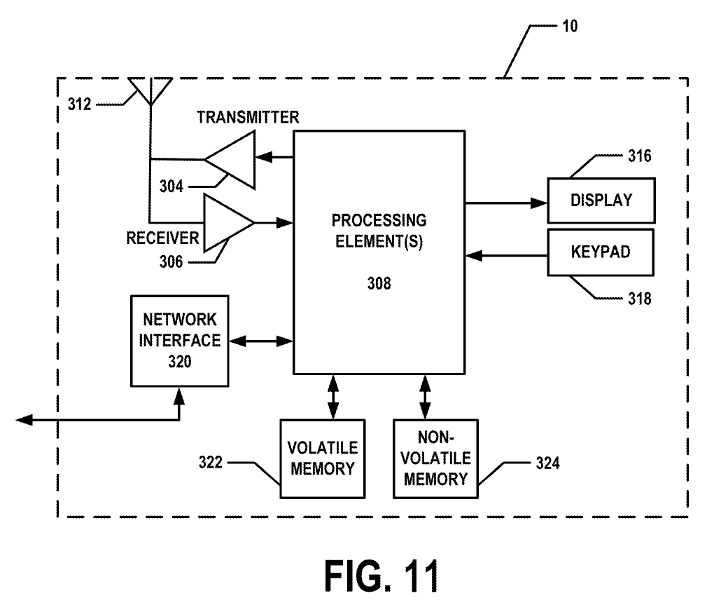

FIG. 11 provides an illustrative schematic diagram of an example computing entity 10 that can be used in conjunction with embodiments of the present invention. In various embodiments, a computing entity 10 is configured to allow a user to provide input to the quantum computer 110, 110’ (e.g., via a user interface of the computing entity 10) and receive, display, analyze, and/or the like output from the quantum computer 110, 110’. For example, a user may operate a computing entity 10 to generate and/or program a quantum algorithm and/or quantum circuit that may be provided such that the controller 30 may receive the quantum algorithm and/or quantum circuit and cause the quantum computer 110, 110’ to perform the quantum algorithm and/or quantum circuit.

As shown in FIG. 11, a computing entity 10 can include an antenna 312, a transmitter 304 (e.g., radio), a receiver 306 (e.g., radio), and a processing element 308 that provides signals to and receives signals from the transmitter 304 and receiver 306, respectively, which may collectively be referred to a transceiver. The signals provided to and received from the transmitter 304 and the receiver 306, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 includes one or more network interfaces 320 configured to communicate (e.g., with the controller 30 and/or one or more other computing entities 10) via one or more wired and/or wireless networks 20.

The computing entity 10 may also comprise a user interface device comprising one or more user input/output interfaces (e.g., a display 316 and/or speaker/speaker driver coupled to a processing element(s) 308 and a touch screen, keyboard, mouse, and/or microphone coupled to a processing element(s) 308). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile memory or storage 322 and/or non- volatile memory or storage 324, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A photonic integrated circuit (PIC) comprising: a PIC body;
at least one input defined in one or more entrance sides of the PIC body; one or more outputs defined in one or more exit sides of the PIC body;
at least one waveguide defined in the PIC body, the at least one waveguide optically coupling the at least one input to a respective output of the one or more outputs; and
a coating that covers an exterior surface of at least the one or more exit sides of the PIC body, wherein one or more apertures formed through the coating, each aperture of the one or more apertures coinciding with a respective output of the one or more outputs, wherein the coating is optically opaque or metal.

2. The PIC of claim 1, wherein the coating further covers the exterior surface of at least one
(a) at least one lateral side of the PIC body or (b) at least one of the one or more entrance sides.

3. The PIC of claim 1, wherein the coating extends out from the exterior surface of the PIC body by a thickness in a range of 15 nm to 1 μm.

4. The PIC of claim 1, wherein the one or more outputs comprise a first output and a second output and the at least one waveguide comprises a first waveguide and a second waveguide, the PIC further comprising a trench baffle disposed at least one of (a) between the first output and the second output or (b) between at least a portion of the first waveguide and at least a portion of the second waveguide.

5. The PIC of claim 1, wherein each of the one or more apertures is etched or milled into the PIC body to form respective sidewalls and a respective back wall and the respective output is disposed on the respective back wall of the respective aperture.

6. The PIC of claim 5, wherein a length of the respective sidewalls in a direction substantially parallel to an emission direction of the one or more outputs is configured to prevent generation of a diffraction pattern in light outputted through the one or more outputs.

7. The PIC of claim 5, wherein a distance between opposite respective sidewalls of the respective aperture is larger than an expected mode field diameter of an optical beam the respective output is configured to output.

8. The PIC of claim 1, further comprising one or more alignment features formed on or in the PIC body and detectable through the coating.

9. The PIC of claim 1, wherein the PIC body comprises one or more claddings enclosing the at least one waveguide in directions perpendicular to an emission direction of the at least one waveguide.

10. The PIC of claim 1, wherein at least one output of the one or more outputs comprises a signal manipulation element.

11. A method of fabricating a photonic integrated circuit (PIC), the method comprising: forming a PIC body including at least one input, one or more outputs, and at least one
waveguide optically coupling the at least one input to at least a respective output of the one or more outputs;
conformally depositing a coating onto an exterior surface of one or more exit sides of the PIC body, wherein the coating is optically opaque or metal; and
forming one or more apertures through the coating, each aperture of the one or more apertures coinciding with a respective output of the one or more outputs.

12. The method of claim 11, wherein the one or more apertures are formed using an etching or milling technique.

13. The method of claim 11, wherein the one or more apertures are formed using lithographical etching, a lift-off process, or shadow masking.

14. The method of claim 11, wherein the one or more apertures are formed using a focused ion beam (FIB).

15. The method of claim 11, wherein the coating further covers the exterior surface of at least one lateral side of the PIC body.

16. The method of claim 11, wherein the coating is deposited on the exterior surface using at least one of (a) sputter deposition (b) atomic layer deposition (ALD), or (c) evaporation deposition.

17. The method of claim 1, further comprising, prior to depositing the coating, forming one or more alignment features on or in the PIC body, wherein the one or more alignment features are detectable after the coating is deposited on the exterior surface.

18. The method of claim 17, wherein at least one of the one or more alignment features are used in alignment of the PIC body for the etching of the PIC body to form the one or more etched and/or milled apertures.

19. The method of claim 11, further comprising, prior to depositing the coating on the exterior surface, at least one of:
etching a trench configured to provide a trench baffle upon deposition of the coating, or applying an adhesion layer to the exterior surface.

20. A quantum system comprising: a confinement apparatus;
one or more manipulation sources; and
at least one beam delivery system configured to provide manipulation signals generated by the one or more manipulation sources to respective locations defined by the confinement apparatus, wherein the beam delivery system comprises a photonic integrated circuit (PIC), the PIC comprising:
a PIC body;
at least one input defined in the PIC body;
one or more outputs defined in one or more exit sides of the PIC body;
at least one waveguide defined in the PIC body, the at least one waveguide optically coupling the at least one input to a respective output of the one or more outputs; and
a coating that covers an exterior surface of at least the one or more exit sides of the PIC body, wherein one or more apertures formed through the coating, each aperture of the one or more apertures coinciding with a respective output of the one or more outputs, wherein the coating is optically opaque or metal.
